(19) United States
(12) Patent Application Publication
(10) Pub. No.: US 2026/0188951 A1
(43) Pub. Date: Jul. 2, 2026

(54) LOCKING DEVICE FOR AN ELECTRICAL OR ELECTRONIC CONNECTOR

(71) Applicant: BANKS AND ACQUIRERS INTERNATIONAL HOLDING, SURESNES (FR)

(72) Inventor: Vincent HERNANDEZ, CLAVEYSON (FR)

(21) Appl. No.: 18/856,916

(22) PCT Filed: Apr. 17, 2023
(86) PCT No.: PCT/EP2023/059939

§ 371 Date: Oct. 15, 2024

(30) Foreign Application Priority Data
Apr. 15, 2022 (FR) FR2203517

(51) Int. Cl. H01R 13/639

(52) U.S. Cl. CPC H01R 13/639

(57) ABSTRACT

A locking device for an electrical or electronic connector having first and second connection members, the locking device including a frame receiving the first connection member, and a locking member cooperating with the second connection member in order to prevent a disconnection of the connector. The locking member is mounted on the frame in such a way as to be movable between a locking position, in which it prevents a disconnection of the connector, and an unlocking position, in which it enables a disconnection of the connector. The locking member includes manoeuvring mechanisms intended to be placed in contact with a finger of a user in order to move the locking member between the locking and unlocking positions. An indentation is formed in the frame and has an opening, the first connection member being arranged in the frame, facing the opening.

### FIELD OF THE INVENTION

The invention relates to the field of locking devices for electrical or electronic connectors. The invention relates more particularly to the electronic payment terminals comprising such locking devices and connection members for electrical or electronic connectors.

### BACKGROUND

The state of the art already describes locking devices for electrical or electronic connectors used to maintain the connection between the connection members of an electrical or electronic connector. The connection members of a connector typically comprise a cable provided with a male or female plug intended to be inserted into a complementary female or male socket. These locking devices are intended to prevent any accidental disconnection between the plug and the socket, in particular when the cable attached to the plug is stressed, while avoiding weakening or stressing the connector. In the prior art, these locking devices typically comprise screwing means used to maintain the plug and socket of the connector in position. Thus, the user requires a tool to unscrew the screwing means in order to unlock the locking means and therefore disconnect the connector. Similarly, a tool is required to lock the locking device.

Such devices have several disadvantages. Firstly, they are expensive and complex to produce since the screwing means generally comprise metallic inserts to be added in the device to cooperate with a screw which is also metallic. In some cases, the costs can be reduced by using inserts and screws made of plastic material, but in this case, the resulting locking device is fragile. In addition, in all cases, these locking devices require the use of a tool to lock or unlock the locking device, which is not practical for the user.

The invention aims in particular to provide a locking device for an electrical or electronic connector allowing simple, inexpensive and tool-free locking of the connector.

Thus, the invention relates to a locking device for an electrical or electronic connector comprising first and second complementary connection members that can be inserted into each other, the locking device comprising:
a frame intended to receive the first connection member,
a locking member intended to cooperate with the second connection member in order to prevent a disconnection between the first and second connection members,
wherein the locking member is mounted on the frame in such a way as to be movable between a locking position, in which it cooperates with the second connection member to prevent a disconnection between the first and second connection members, and an unlocking position which it enables a disconnection between the first and second connection members, and wherein the locking member comprises manoeuvring means intended to be placed in contact with a finger of a user in order to move the locking member between the locking and unlocking positions,
characterised in that an indentation is formed in the frame and has an opening, the first connection member being arranged in the frame, facing the opening.

The locking member is used to lock the connection between the first and second connection members of the connector. In addition, it reduces the stresses imposed on the connector when the second connection member is stressed, for example via a connection cable to which it is attached.

Thanks to the locking device according to the invention, the user does not require a tool to move the locking member between its locking position and its unlocking position, since it can be manoeuvred simply by the manoeuvring means between these positions. We also note that the locking member is mounted on the frame when it is in the locking position but also when it is in the unlocking position. The locking device is therefore easier to use since the user does not need to remove a part of the locking device when it is in the unlocking position, with the risk of losing it. This also means that the locking device can be handled with one hand during unlocking.

The presence of the indentation formed in the frame offers several advantages. Firstly, this indentation performs a protection function. The arrangement of the first connection member in the frame, facing the opening of the indentation, protects the first connection member against possible impacts with external elements likely to damage it and therefore impair the electrical or electronic connection. Note in particular that the arrangement of the first connection member facing the opening of the indentation keeps this first connection member away from the side walls of the frame so that it is better protected against possible impacts. In addition, the indentation can easily be designed to receive at least a part of the second connection member when it is connected to the first connection member. In this case, the indentation also protects the second connection member and thus reduces the risk of disconnecting and damaging the connector. In addition, the second connection member is typically attached to a connection cable adapted to transmit electronic data or electrical energy. The indentation can thus easily be configured to receive at least one end of this cable attached to the second connection member. Thus, the indentation forms a means of protection limiting the risks of accidental torsion of the cable at its end used to connect to the second connection member. The junction between the cable and the second connection member is in fact a weak point which must be protected to avoid any risk of damage, such as partial or total section.

Furthermore, the indentation forms a means for guiding the second connection member in the insertion direction so that the second connection member is perfectly aligned with the first connection member so as to reduce the risk of damaging the connection members during insertion. Thus, to avoid damaging the transmission of data or electrical energy between the first and second connection members, these members must not be deformed, especially during incorrect handling or by exerting a physical stress on the first or second connection member.

An electrical connector is a connector used for the transmission and the supply of electrical energy. Such connectors are, for example, those defined in standard 60320 of the International Electrotechnical Commission (IEC), such as a connector comprising a pair of connection members C5/C6. An electronic connector is a connector used for the transmission of information or data, used in particular in information technology. Such electronic connectors are, for example and non-exhaustively, USB (USB-A, USB-B, USB-C, etc.), Ethernet (RJ45), HDMI, DisplayPort or MiniDisplayPort type connectors. Some connectors can provide both an electrical and electronic connection, for example USB type connectors.

The connector comprises first and second complementary connection members that can be inserted into each other which correspond respectively to a socket and a plug of the connector. In one embodiment, the socket is a male connection member and the plug is a female connection member. In another embodiment, the socket is a female connection member and the plug is a male connection member.

The invention may also comprise one or more of the following optional characteristics, taken alone or in combination.

The indentation is formed in a lower wall of the frame and has a generally parallelepipedic shape flared at a first longitudinal end opening out onto an upper end of the frame, the opening being formed in the indentation at a second longitudinal end of the indentation, opposite the first longitudinal end. The parallelepipedic shape of the indentation makes the locking device easier to manufacture and simplifies the guiding of the second connection member in the indentation when making the connection. The device is therefore easier to use and the risk of damaging the connector due to handling errors is reduced. In addition, the flared shape of this indentation at its first longitudinal end makes it easier to insert the second connection member in the indentation and therefore makes it easier to connect the first and second connection members.

The locking member is configured to move from the unlocking position to the locking position according to a movement in a direction orthogonal to a direction of insertion of the second connection member in the first connection member. This configuration gives the locking member good resistance to tearing by traction on the second connection member by opposing the direction of withdrawal of this second connection member. This configuration is particularly useful when traction is exerted accidentally on a cable to which the second connection member is attached.

The locking device further comprises blocking means using cooperation of shapes for blocking the locking member in the unlocking position. Thus, the blocking means are held simply and inexpensively in the unlocking position when this is necessary, for example while waiting for a connection between the first and second connection members of the connector, which makes the locking device easier to use. According to one embodiment, the locking member and the frame comprise complementary reliefs forming the blocking means. These complementary reliefs are intended to be inserted into each other when the locking member is in the unlocking position and are configured to hold it in this position. The locking member could comprise a male relief and the frame a complementary female relief. This embodiment offers the advantage that when the locking member moves relative to the frame, it is not scratched by the relief of the frame and is therefore not damaged. The locking member could also comprise a female relief and the frame a complementary male relief. This embodiment offers the advantage that when the locking member moves relative to the frame, it does not scratch the frame which is therefore not damaged.

The locking device further comprises blocking means using cooperation of shapes for blocking the locking member in the locking position. Thus, the blocking means are held simply and inexpensively in the locking position when this is necessary, for example as long as the connection between the first and second connection members of the connector is required, which makes the locking device easier to use. This configuration is particularly advantageous to hold the locking device in the locking position even if the second connection member is stressed, to a greater or lesser extent, in the disconnection direction.

The manoeuvring means for manoeuvring the locking member comprise a disengagement pin, the locking member forming an elastic core so that when a user presses on the disengagement pin against an elastic return force of the locking member, the blocking means using cooperation of shapes for blocking the locking member in the locking position are disengaged, enabling the locking member to move to the unlocking position. Thus, the user can disengage the blocking means simply and intuitively. By pressing on the disengagement pin, the user elastically deforms the core of the locking member slightly so as to disengage the blocking means, in other words so as to separate the complementary shapes, to disable the blocking means and therefore allow the movement from the locking position to the unlocking position. Note that this disengagement can be carried out by a user with a single hand, which is particularly practical.

At least a part of the locking member is retracted into the frame in the locking position. Thus, the resistance to tearing of the locking member is improved since some of the force exerted on the locking member is taken up by the frame, thus relieving the locking member.

The locking member forms a slide that can be moved in translation. This is a simple and robust embodiment of the locking member. To move from a locking position to an unlocking position or from an unlocking position to a locking position, a user manoeuvres the manoeuvring means for manoeuvring the locking member with their finger to make it slide in a first direction to lock the locking member and in a second direction, opposite to the first direction, to unlock the locking member. This movement is simple and intuitive for the user to perform and simple and inexpensive to implement on the locking device.

The locking member can be moved by rotation. This is a simple and robust embodiment of the locking member. To move from a locking position to an unlocking position or from an unlocking position to a locking position, a user manoeuvres the manoeuvring means for manoeuvring the locking member with their finger to pivot the locking member in a first direction of rotation and lock the locking member and in a second direction of rotation, opposite to the first direction, to unlock the locking member. This movement is simple and intuitive for the user to perform and simple and inexpensive to implement on the locking device.

Also described is a connection member for an electrical or electronic connector, comprising a complementary locking member intended to cooperate with the locking member of a locking device as described previously to prevent a disconnection between the connection member, called second connection member, and a first connection member that are complementary and that can be inserted into each other when the locking member is in the locking position.

The connection member, called second connection member, is typically a plug for an electrical or electronic connector as described previously. This plug can be male or female and is complementary to the first connection member, also called socket, which is female or male, respectively. The cooperation between the complementary locking member and the locking member thus prevents the disconnection between the first and second connection members of the electrical or electronic connector.

Advantageously, the complementary locking member comprises a locking stop protruding from a side of the connection member and intended to cooperate with the locking member to prevent a disconnection between the first and second connection members of the electrical or electronic connector when the locking member is in the locking position. In addition to preventing the disconnection between the first and second connection members, this locking stop takes up the forces exerted by the connector, and in particular the second connection member and, possibly, a connection cable attached to the second connection member. Thus, the connector is protected, the risk of breakage or wear is reduced and the lifetime of the device is therefore extended.

Preferably, the complementary locking member further comprises a guiding stop protruding from the same side of the connection member as the locking stop and intended, in cooperation with the locking stop, to help guide the locking member as it moves between an unlocking position and a locking position. The guiding stop and the locking stop form together a guide surrounding the locking member to ensure that it moves correctly between its unlocking position and its locking position. This avoids the presence of slight shifts in the position of the locking member which could create play that would impair its locking function.

The invention also relates to an electronic payment terminal, characterised in that it comprises a locking device as described previously and an electrical or electronic connector comprising a connection member as described previously.

### BRIEF DESCRIPTION OF THE FIGURES

The invention will be better understood on reading the description which follows, given purely by way of non-limiting examples and with reference to the attached drawings in which:

FIG. 1 is a perspective view of a lower side of an electronic payment terminal comprising a locking device according to a first embodiment of the invention;

FIG. 2 is a view of a part of the lower side of the electronic payment terminal of FIG. 1, in which the locking device is in the locked position;

FIG. 3 is a view similar to FIG. 2, in which the locking device is in the unlocked position;

FIG. 4 is an exploded view of a locking member of the locking device shown on FIGS. 1 to 3 and of the first and second connection members of the electronic connector of the electronic payment terminal shown on FIGS. 1 to 3.

FIG. 5 is a perspective view of a part of an electronic payment terminal comprising a locking device according to a second embodiment of the invention and in which the locking device is in the locking position.

FIG. 6 is a view similar to FIG. 5, in which the locking device is in the unlocking position.

FIG. 7 is a view similar to FIG. 5, in which the frame of the locking device is not shown.

### DETAILED DESCRIPTION

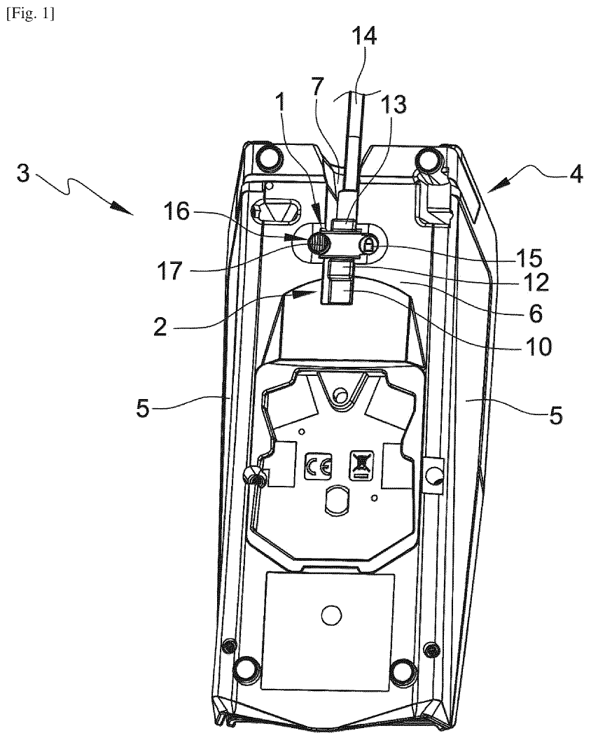

We will now describe, in reference to FIGS. 1 to 7, two embodiments of a locking device 1 for an electrical or electronic connector 2 according to the invention, integrated in an electronic payment terminal 3 according to the invention.

The first embodiment is shown on FIGS. 1 to 4. The electronic payment terminal 3 typically comprises a magnetic card reader on one of its side walls and a smart card reader at its lower end, readers in which a payment card (not shown) can be inserted to make a bank transaction for example. Obviously, according to other embodiments, the terminal used could be another type of terminal, for example car park or secure room access control terminal.

The locking device 1 comprises a frame 4, also called a box. The frame 4 forms in particular the side walls 5 and the lower wall 6 of the electronic payment terminal 3 and houses the various electronic components of the electronic payment terminal 3, which are known per se and which will not be described here. An indentation 7 is formed in the lower wall 6 of the frame 4, this indentation 7 having a generally parallelepipedic shape flared at its end opening out onto the upper end of the electronic payment terminal 3 (see FIGS. 1 to 3). Opposite this flared end, the indentation 7 has an opening 8 in the frame 4. Note that the lower wall 6 of the frame 4 is intended to be placed on a substantially flat surface, for example a table top or a cash register counter.

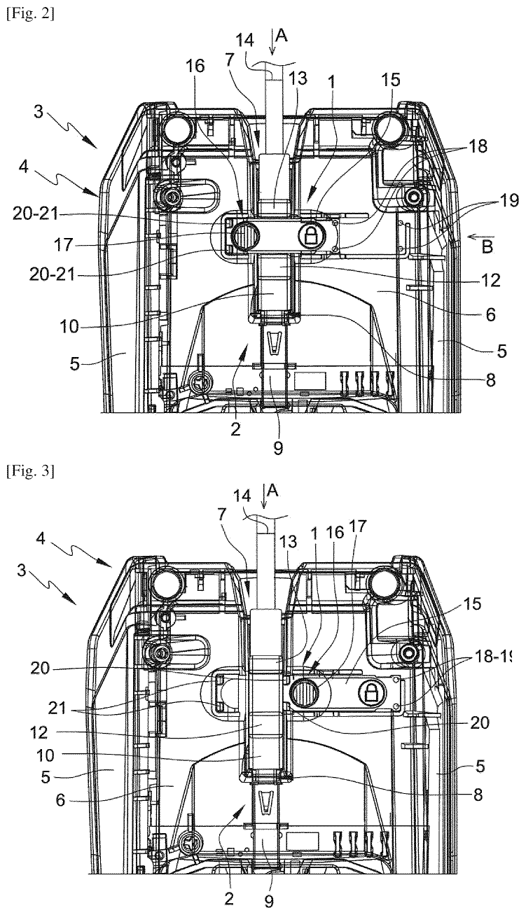

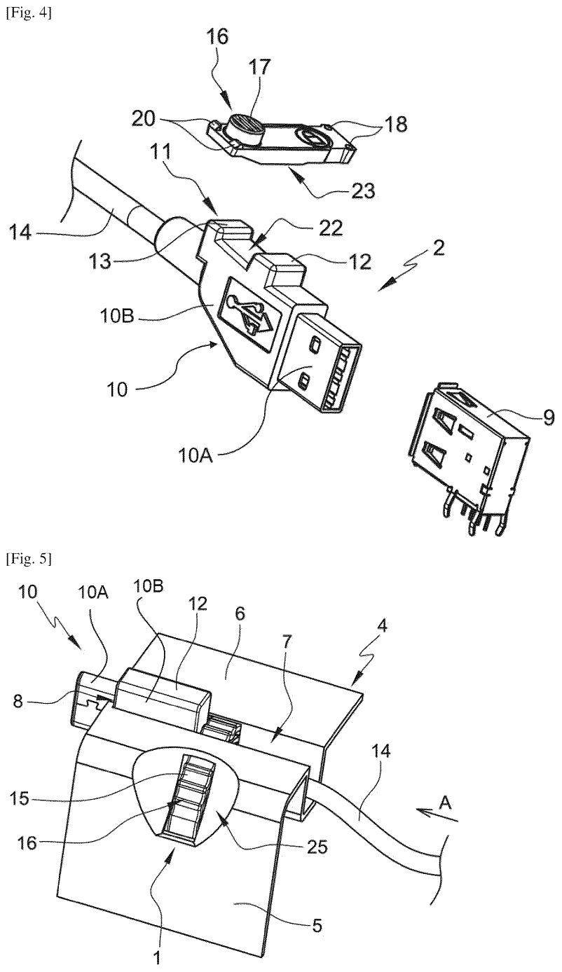

The electrical or electronic connector 2 is in this case a type A USB connector (see FIG. 4). Such a connector 2 is adapted to transmit data and electrical energy. The connector 2 comprises a first connection member 9, also called socket, which in this case is of the female type, and a second connection member 10, also called plug, which in this case is of the male type. Note that the second connection member 10 comprises a first part 10A intended to be in contact, in particular in electrical or electronic contact, by insertion with the first connection member 9 and a second part 10B forming an insulating manoeuvring sheath. The first connection member 9 and the second connection member 10 are thus complementary and can be inserted into each other to make an electrical or electronic connection. The first connection member 9 is received in the frame 4 which comprises attachment means (not shown) to hold the first connection member 9 facing the opening 8 of the indentation 7 (see FIGS. 2 and 3).

The second part 10B of the second connection member 10 comprises a member, called complementary locking member 11. In this embodiment, this complementary locking member 11 comprises a locking stop 12 protruding from a side of the second connection member 10 and a guiding stop 13 protruding from the same side of the second connection member 10 as the locking stop 12 (see FIG. 4). The second connection member 10 is provided at one of its ends with a cable 14 adapted to transmit data or electrical energy. When a connection between the first 9 and second 10 connection members is required, the second connection member 10 is inserted in the indentation 7 from its flared end up to its other end where the opening 8 used to access the first connection member 9 is located. This insertion therefore takes place along an insertion direction shown by the arrow A on FIGS. 2 and 3. Note that the indentation 7 is designed so that the opening 8, to access the first connection member 9, is set back sufficiently from one of the side walls 5 of the frame 4 and from the upper end of the terminal 3 to house, in the indentation 7, the second part 10B of the second connection member 10 and a part of the cable 14, in particular when the first 9 and second 10 connection members are inserted into each other. Thus, the indentation 7 forms a means of protection limiting the risks of accidental torsion of the cable 14 at its end used to connect to the second connection member 10. The junction between the cable 14 and the second connection member 10 is in fact a weak point which must be protected to avoid any risk of damage, such as partial or total section. Furthermore, the indentation 7 forms a means for guiding the second connection member 10 in the insertion direction so that the second part 10B of the second connection member 10 is perfectly aligned with the first connection member 9 so as to reduce the risk of damaging the connection members during insertion. Thus, to avoid impairing the transmission of data or electrical energy between the first 9 and second 10 connection members, these members must not be deformed, especially during incorrect handling or by exerting a physical stress on the first connection member 9 or on the second part 10B of the second connection member 10.

The locking device 1 further comprises a locking member 15 intended to cooperate with the second part 10B of the second connection member 10 in order to prevent a disconnection between the first 9 and second 10 connection members. In this embodiment, the locking member 15 forms a slide that can be moved in translation. The locking member 15 is thus mounted on the frame 4 in such a way as to be able to slide between a locking position (see FIG. 2), in which it cooperates with the second connection member 10 to prevent a disconnection between the first 9 and second 10 connection members, and an unlocking position (see FIG. 3) in which it enables a disconnection between the first 9 and second 10 connection members. The locking member 15 is partially retracted behind the frame 4, whether in the unlocking position or the locking position. This retraction is advantageous in the locking position since it increases the tearing resistance of the locking member 15. Note that the movement from the locking position to the unlocking position is carried out by retracting the locking member 15 slightly further behind the frame 4, which offers the advantage of not taking up too much space.

The locking member 15 further comprises manoeuvring means 16, comprising in this case a disengagement pin 17. The manoeuvring means 16 are intended to be placed in contact with a finger of a user in order to move the locking member 15 between the locking and unlocking positions. The locking member 15 is configured to move from the locking position to the unlocking position in a direction B orthogonal to the direction A of insertion of the second connection member 10 in the first connection member 9 (see FIG. 2). In this case, this movement from the unlocking position to the locking position consists in a rectilinear translation by sliding the slide in the direction B.

The locking device 1 further comprises blocking means using cooperation of shapes for blocking the locking member 15 in the unlocking position (see FIG. 3). In this case, these blocking means comprise complementary reliefs present on the locking member 15 and the frame 4. Thus, the locking member 15 comprises at a first one of its longitudinal ends two cavities 18 of hemispherical shape formed on one side of the locking member 15 opposite the frame 4 when the locking member 15 is mounted on the frame 4. The frame 4 comprises two lugs 19 each having a shape complementary to that of one of the cavities 18. The cavities 18 and the lugs 19 are configured to be facing each other when the locking member 15 is in the unlocking position, the cavities 18 and the lugs 19 then engaging with each other so as to block the locking member 15 in the unlocking position. The means for blocking the locking member 15 in the unlocking position are configured so that they can be disengaged when a sufficient force is provided by a user who manoeuvres the locking member 15, for example using the manoeuvring means 16, in the locking direction B. Thanks to these blocking means, the second connection member 10 can easily be inserted without having to hold the locking member 15 in the unlocking position. Depending on the embodiments, the number, shape and distribution of the complementary reliefs may change. For example, the locking member 15 could carry the lugs and the frame 4 could comprise the cavities.

The locking device 1 further comprises blocking means using cooperation of shapes for blocking the locking member 15 in the locking position (see FIG. 2). In this case, these blocking means comprise complementary reliefs present on the locking member 15 and the frame 4. Thus, the locking member 15 comprises at a second one of its longitudinal ends two lugs 20 comprising in particular a flat side protruding orthogonally from the side of the locking member 15 facing the frame 4 when the locking member 15 is mounted on the frame 4. The frame 4 comprises two cavities 21 having a shape complementary to that of the lugs 20. The lugs 20 and the cavities 21 are positioned to be facing each other when the locking member 15 is in the locking position, the cavities 21 and the lugs 20 then engaging with each other so as to block the locking member 15 in the locking position. Unlike the means for blocking the locking member 15 in the unlocking position, the means for blocking the locking member 15 in the locking position prevent, in this case, a disengagement when a sufficient force is provided by a user who manoeuvres the locking member 15. This is due in particular to the cooperation between the orthogonal flat side of each of the lugs 20 and the complementary shape of each of the respective cavities 21 of the frame 4. Thus, the disengagement of the means for blocking the locking member 15 in the locking position requires the use of the disengagement pin 17. This further improves the locking by reducing the risk of accidental disengagement of the means for blocking the locking member 15 in the locking position. When a user presses on the disengagement pin 17 while the locking member 15 is in the locking position, the core of the locking member 15 deforms elastically so that the lugs 20 come out of the cavities 21 of the frame 4 and therefore disengage the blocking means, thus enabling the locking member 15 to move by sliding towards the unlocking position. When the locking member 15 is moved to the locking position, the elastic return force of the core of the locking member 15 allows the lugs 20 to engage automatically in the cavities 21 when they are facing, like a strike and bolt type mechanism.

The stop 12 locking the complementary locking member 11 of the second part 10B of the second connection member 10 is intended to cooperate with the locking member 15 to prevent a disconnection between the second connection member 10 and the first connection member 9 when the locking member 15 is in the locking position. This cooperation takes place in particular when the locking stop 12 abuts against the locking member 15 in the locking position during a traction of the second connection member 10 in the direction opposite to the insertion direction A. This stop thus prevents the withdrawal of the second connection member 10 and therefore the disconnection between the first 9 and second 10 connection members. The cooperation between the complementary locking member 11 and the locking member 15 also prevents a movement in the upward direction with reference to FIG. 4, in other words a direction orthogonal to the direction A of insertion of the second connection member 10. Thus, the complementary locking member 11 comprises a complementary locking stop 22 formed by a portion of the upper wall of the second connection member 10 that is located between the locking stop 12 and the guiding stop 13. This complementary locking stop 22, in case of an attempt to move the second connection member 10 upwards, abuts against the lower wall 23 of the locking member 15 and cooperates with it in order to prevent the movement of the second connection member 10 and therefore a disconnection between the first 9 and second 10 connection members. This therefore avoids stressing the connector 2 in directions which could damage it or cause a disconnection of the connector 2.

The guiding stop 13 of the complementary locking member 11 is intended, in cooperation with the locking stop 12, to help guide the locking member 15 as it moves between an unlocking position and a locking position or between a locking position and an unlocking position. It defines with the locking stop 12 a portion of guiding rail for the locking member 15 as it slides between its locking and unlocking positions.

We will now describe the operation of the electronic payment terminal 3 comprising the locking device 1 as described above.

Firstly, a connection between the first 9 and second 10 connection members of the connector 2 is required. These two members are therefore disconnected and the locking member 15 of the locking device is held in the unlocking position by the means for blocking in the unlocking position. To make the connection, a user inserts, in the insertion direction A, the second connection member 10 in the indentation 7 of the frame up to the opening 8 used to access the first connection member 9 to connect these two members (see FIG. 3).

Secondly, a locking of the connection of the connector 2 is required. To do this, a user manoeuvres the manoeuvring means 16, formed in this case by the disengagement pin 17, with their finger to slide the locking member 15 in the direction B towards the locking position. Sufficient force must be applied by the user's finger in order to disengage the means for blocking the locking member 15 in the unlocking position. Once the blocking means have been disengaged, the user continues to slide the locking member 15 by moving it between the locking stop 12 and the guiding stop 13 until the disengagement pin 17 abuts against a wall of the frame 4 and the lugs 20 and the cavities 21 of the means for blocking the locking member 15 in the locking position engage with each other so as to hold the locking member 15 in the locking position (see FIG. 2). Once this position has been obtained, the connection is locked and secured, it is no longer possible to separate the first connection member 9 and the second connection member 10 of the connector 2. In addition, if the cable 14 should be deliberately or accidentally stressed, the locking device 1 takes up some of the force applied on the connector so that it is not stressed excessively, which reduces the risk of wear and malfunction of the connector 2.

Thirdly, a disconnection between the first 9 and second 10 connection members is required. To do this, the user presses on the disengagement pin 17 so as to disengage the blocking means in the locking position of the locking member 15 as described previously, then, still using the disengagement pin 17 to manoeuvre the locking member 15, slides this locking member 15 towards the unlocking position until the means for blocking the locking member 15 in the unlocking position are engaged (see FIG. 3). The user can then disconnect the connector 2 by pulling the second connection member 10 or the cable 14 in the direction opposite to the insertion direction A until the second connection member 10 is disengaged from the indentation 7 of the frame 4.

It is noted that, advantageously, to lock and unlock the locking device 1, the user did not require a tool, they simply had to use their finger to manoeuvre the manoeuvring means 16, and in particular the disengagement pin 17. This makes the locking device 1 particularly simple and practical to use.

The second embodiment of the invention is shown on FIGS. 5 to 7. For clarity purposes, the same numerical references have been used for the same elements in the two embodiments. The second embodiment is only described with respect to its differences compared with the first embodiment, the elements not described must therefore be considered as being identical to those of the first embodiment.

The main difference between the first and second embodiments lies in the type of movement made by the locking member 15 between its locking and unlocking positions. In the second embodiment, the locking member 15 is not a slide which slides between these positions but a locking member 15 that can be moved by rotation.

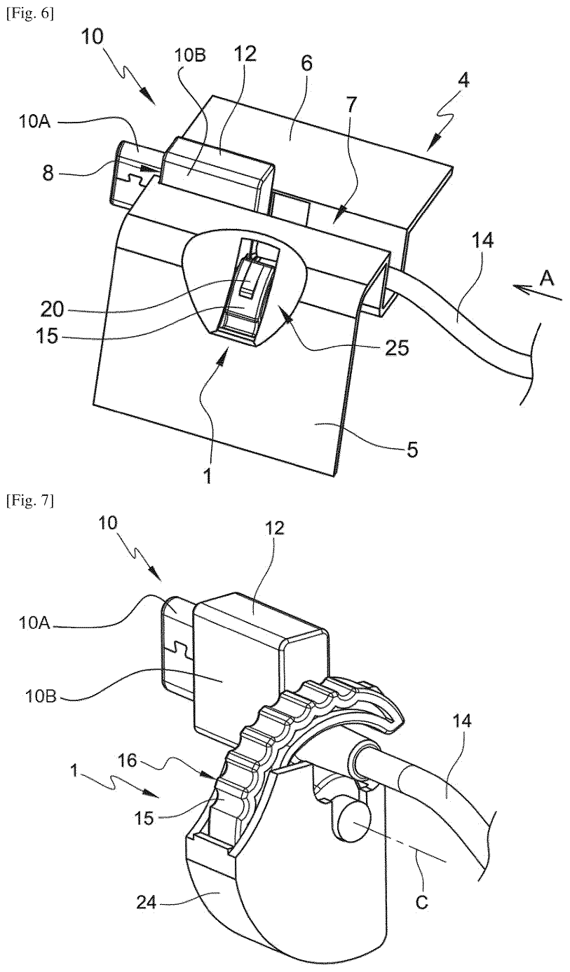

The locking member 15 of this embodiment therefore has the shape of a curved finger which is mounted so as to pivot in rotation about a rotation axis C (see FIG. 7). The frame 4 comprises a housing 24 intended to receive the mechanism of the locking member 15 enabling it to make this pivoting movement. The radially external surface of the locking member 15 is notched, which forms the manoeuvring means 16 for manoeuvring the locking member 15. To make the locking member 15 easier to handle, an indentation is formed in the frame 4 which is provided with an opening 25 used to access the manoeuvring means 16 for manoeuvring the locking member 15 (see FIGS. 5 and 6).

Unlike the first embodiment, the complementary locking member 11 does not comprise a guiding stop but only a locking stop 12. In addition, note that in this case, a type C USB connector is used. Note also that in the example described, the axis C is parallel or substantially parallel to the axis of the direction of insertion of the second connection member 10 in the indentation 7. Thus, the locking member 15 is not, in the locking position, in contact with the cable 14 but only with the locking stop 12. Consequently, there is no risk of the locking member 15 damaging the cable 14, for example by crushing or by section.

In this embodiment, the means for blocking the locking member 15 in the locking position only comprise a single lug 20 carried by the locking member 15 and having a shape complementary to that of a cavity (not shown) present in the frame 4. In this embodiment, the disengagement of the means for blocking the locking member 15 in the locking position does not require a disengagement pin, the user simply has to apply a sufficient force in the unlocking direction using the manoeuvring means 16 for manoeuvring the locking member 15.

We will now describe the operation of the electronic payment terminal 3 comprising the locking device 1 according to the second embodiment of the invention.

Firstly, a connection between the first (not shown) and second 10 connection members of the connector is required. These two members are therefore disconnected and the locking member 15 of the locking device is held in the unlocking position by means for blocking in the unlocking position (not shown). To make the connection, a user inserts, in the insertion direction A, the second connection member 10 in the indentation 7 of the frame up to the opening 8 used to access the first connection member to connect these two members (see FIG. 6).

Secondly, a locking of the connection of the connector is required. To do this, a user manoeuvres the manoeuvring means 16, formed in this case by the notches of the notched edge of the curved finger, with their finger to pivot the locking member 15 about the axis C towards the locking position. Sufficient force must be applied by the user's finger in order to disengage the means for blocking the locking member 15 in the unlocking position. Once the blocking means have been disengaged, the user continues to pivot the locking member 15 by rolling the notched edge with their finger until the lug 20 engages in the cavity of the means for blocking in the locking position so as to hold the locking member 15 in the locking position (see FIG. 5). Once this position has been obtained, the connection is locked and secured, it is no longer possible to separate the first connection member and the second connection member 10 of the connector. In addition, if the cable 14 should be deliberately or accidentally stressed, the locking device 1 takes up some of the force applied on the connector so that it is not stressed excessively, which reduces the risk of wear and malfunction of the connector.

Thirdly, a disconnection between the first and second 10 connection members is required. To do this, the user exerts a force on the notches of the manoeuvring means 16 in the direction opposite to that in which a force was exerted to move to the locking position until this force is sufficient to disengage the means for blocking the locking member 15 in the locking position. Then, still using the notched edge, the user uses their finger to pivot the locking member 15 towards the unlocking position until the means for blocking the locking member 15 in the unlocking position are engaged (see FIG. 6). The user can then disconnect the connector by pulling the second connection member 10 or the cable 14 in the direction opposite to the insertion direction A until the second connection member 10 is disengaged from the indentation 7 of the frame 4.

As for the first embodiment, note that, advantageously, to lock and unlock the locking device 1, the user does not require a tool, they simply have to use their finger to manoeuvre the manoeuvring means 16, in this case the notched edge of the locking member 15. This makes the locking device 1 particularly simple and practical to use.

The invention is not limited to the embodiments described and other embodiments will be clearly apparent to those skilled in the art. In particular, the shape of the complementary locking member could be different from that of a locking member completed or not with a guiding stop. For example, the complementary locking member forms a through-hole through which the locking member is intended to pass when moving from the unlocking position to the locking position.

### LIST OF REFERENCES

1: locking device
2: electrical or electronic connector
3: electronic payment terminal
4: frame
5: side wall of the frame
7: indentation in the frame
8: access opening in the indentation
9: first connection member
10: second connection member
10A: first part of the second connection member
10B: second part of the second connection member
11: complementary locking member
12: locking stop
13: guiding stop
14: cable
15: locking member
16: manoeuvring means for manoeuvring the locking member
17: disengagement pin
18: cavity of the means for blocking in the unlocking position
19: lug of the means for blocking in the unlocking position
20: lug of the means for blocking in the locking position
21: cavity of the means for blocking in the unlocking position
22: complementary locking stop
23: lower wall of the locking member
24: housing
25: opening to access the manoeuvring means

1. A locking device for an electrical or electronic connector comprising first and second connection members that are complementary and can be inserted into each other, the locking device comprising:
a frame intended to receive the first connection member,
a locking member intended to cooperate with the second connection member in order to prevent a disconnection between the first and second connection members,
wherein the locking member is mounted on the frame in such a way as to be movable between a locking position, in which it cooperates with the second connection member to prevent a disconnection between the first and second connection members, and an unlocking position in which it enables a disconnection between the first and second connection members,
wherein the locking member comprises manoeuvring means intended to be placed in contact with a finger of a user in order to move the locking member between the locking and unlocking positions, and
wherein an indentation is formed in the frame and has an opening the first connection member being arranged in the frame, facing the opening.

2. The locking device according to claim 1, wherein the indentation is formed in a lower wall of the frame and has a generally parallelepipedic shape flared at a first longitudinal end opening out onto an upper end of the frame, the opening being formed in the indentation at a second longitudinal end of the indentation, opposite the first longitudinal end.

3. The locking device according to claim 1, wherein the locking member is configured to move from the unlocking position to the locking position according to a movement in a direction orthogonal to a direction of insertion of the second connection member in the first connection member.

4. The locking device according to claim 1, further comprising blocking means using cooperation of shapes for blocking the locking member in the unlocking position.

5. The locking device according to claim 1, one of the preceding claims, further comprising blocking means using cooperation of shapes for blocking the locking member in the locking position.

6. The locking device according to claim 4, wherein the manoeuvring means for manoeuvring the locking member comprise a disengagement pin, the locking member forming an elastic core so that when the user presses on the disengagement pin against an elastic return force of the locking member, the blocking means using cooperation of shapes for blocking the locking member in the locking position are disengaged, enabling the locking member to move to the unlocking position.

7. The locking device according to claim 1, wherein at least a part of the locking member is retracted into the frame in the locking position.

8. The locking device according to claim 1, wherein the locking member forms a slide that can be moved in translation.

9. The locking device according to claim 1, wherein the locking member can be moved by rotation.

10. An electronic payment terminal, comprising the locking device according to claim 1 and an electrical or electronic connector comprising a connection member, the connection member comprising a complementary locking member intended to cooperate with the locking member of the locking device to prevent a disconnection between the connection member, called second connection member, and a first connection member that are complementary and that can be inserted into each other when the locking member is in the locking position.

11. The electronic payment terminal according to claim 10, wherein the complementary locking member comprises a locking stop protruding from a side of the connection member and intended to cooperate with the locking member to prevent a disconnection between the first and second connection members of the electrical or electronic connector when the locking member is in the locking position.

12. The electronic payment terminal according to claim 11, wherein the complementary locking member further comprises a guiding stop protruding from the same side of the connection member as the locking stop and intended, in cooperation with the locking stop, to help guide the locking member as it moves between an unlocking position and a locking position.
